(19) United States
(12) Patent Application Publication
(10) Pub. No.: US 2006/0108336 A1
(43) Pub. Date: May 25, 2006

(54) Fabrication process for large-scale panel devices

(75) Inventors: Jerry Ta-Yeh Fang, Palos Verdes Estates, CA (US); Te-Kao Wu, Torrance, CA (US)

Correspondence Address: Patti & Brill, One North LaSalle Street, 44th Floor, Chicago, IL, 60602, US

(73) Assignee: Northrop Grumman Corporation

(21) Appl. No.: 10/995,865

(22) Filed: Nov. 23, 2004

(51) Int. Cl. B23K 26/38

(52) U.S. Cl. 219/121.69

(57) ABSTRACT

A method for forming patterned metal layers to a higher degree of precision than if chemical etching were used. A thin metal layer carried on a thicker metal carrier layer is patterned by laser ablation. Then the thin metal layer, and with it the carrier layer, is laminated to a dielectric layer. Finally the carrier layer is removed, leaving the patterned thin metal layer bonded to the dielectric layer.

### BACKGROUND OF THE INVENTION

This invention relates generally to fabrication of electronic devices, and more particularly to fabrication of devices that are “large-scale,” i.e., devices that require extremely fine tolerances in their geometric features, usually because of the high frequencies at which the devices will be operated. For example, frequency selective surfaces (FSS), polarizers, and patch or slot antenna arrays all require that fine-tolerance metal patterns be formed over a substrate, usually of a dielectric organic material.

Prior to the present invention, such devices were manufactured by using a wet chemical etching process to form a pattern of desired features in the metal layer. More specifically, devices of this type were fabricated either with a subtractive or with an additive process with the aid of lithography. The configurations of the desired features were first defined with in a photoresist layer prior to either of the processes being used. In the subtractive process the wet chemical etchant is uncontrollably sprayed to etch a pre-laminated thick metal foil to a tolerance of approximately 0.7 mil (0.0007 inch) or about 17.8 microns (μm). A straight-line channel etched into a metal layer typically has trapezoidal cross-sectional wall shape due to the nature of the chemical etching reaction. The etchant first attacks the top surface of the metal layer, but then continuously attacks the metal both more deeply and laterally. The uniformity of the etching process becomes unpredictable when the part is large (>12″) and, therefore, the quality of the desired feature is compromised. In the additive process a liquid electroless metal coating is deposited into feature cavities defined by the photoresist. The wall of each cavity is not straight or smooth due to imperfections in the imaging and developing processes. Moreover, the application of the liquid photoresist onto a large part can not be uniformly achieved. Therefore, as a practical matter only small parts (<12″diameter) can be made to the desired feature configuration.

There is clearly a need for a fabrication process for forming feature patterns in a metal layer to a tolerance better than ˜0.0005 inch (˜12.7 μm) without using wet chemical etching. The present invention satisfies this need.

### SUMMARY OF THE INVENTION

The present invention resides in a technique for providing a pattern of desired features in a thin metal layer, without using chemical etching or photoresist masks. Briefly, and in general terms, the method of the invention comprises the steps of taking a structure that includes a thin metal layer removably mounted on a metal carrier layer; forming a pattern of desired geometric features in the thin metal layer using a laser to ablate cavities in the metal; laminating the thin metal layer and the entire structure to a dielectric layer; and removing the metal carrier layer to leave the patterned thin metal layer laminated to the dielectric layer. Forming the pattern in the thin metal layer by laser ablation results in more precisely formed pattern features and in desirably parallel feature sidewalls.

The forming step may, for example, use a neodymium (Nd) and yttrium aluminum garnet (YAG) laser. Preferably, the laminating step uses a low-flow or no-flow adhesive material, or an adhesive-less material. Also, it is preferable that the laser used in the forming step should penetrate the entire thickness of the thin metal layer and partially penetrate the metal carrier layer, to produce desirably parallel sidewalls in each feature of the pattern.

It will be appreciated from the foregoing summary that the present invention is a significant advance in large-scale fabrication processes for devices that have patterned metal layers. In particular, the invention allows a thin metal layer to be patterned with greater precision than with conventional subtractive and additive wet chemical processes. Other aspects and advantages of the invention will become apparent from the following more detailed description of the invention.

### BRIEF DESCRIPTION OF THE DRAWING

FIGS. 1A, 1B, 1C and 1D are cross-sectional views depicting a sequence of process steps performed in accordance with the method of the present invention.

### DETAILED DESCRIPTION OF THE INVENTION

As shown in the drawings for purposes of illustration, the present invention is concerned with a technique for fabricating a device having a patterned metal layer to a high degree of precision, without using wet chemical etching. As discussed briefly above, the wet chemical processes have tolerance limitations and other disadvantages that render it impractical for fabricating many devices operating at high microwave frequencies.

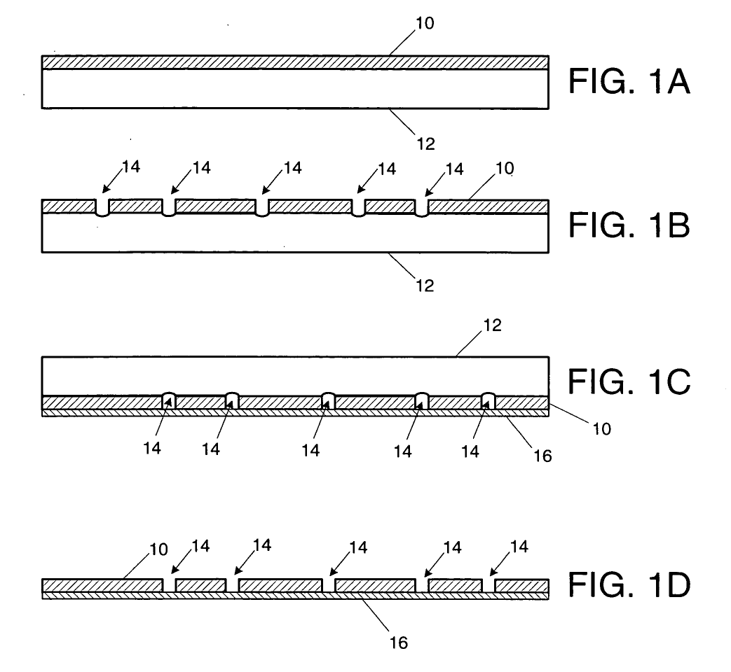

In accordance with the present invention, and as described in more detail below, a commercially available thin copper foil and carrier system is laser ablated to a controlled depth to create the desired design features in a metal layer. FIG. 1A shows the cross section of a commercially available structure that includes a copper foil layer 10 of 3 or 5 microns (μm) thickness bonded to a peelable thicker copper carrier 12. This structure is available, for example, from Circuit Foil Luxembourg Group, G.D. of Luxembourg, sold under the trademark DOUBLETHIN®.

As shown in FIG. 1B, the next step is to form device feature patterns, some of which are shown at 14, in the copper foil layer 10, using a laser to remove the desired material by ablation. For example, a Nd:YAG laser may be used. (Nd is the chemical symbol for neodymium, the active rare earth element in the laser, and the abbreviation YAG stands for yttrium aluminum garnet, a solid-state crystalline material widely used in lasers.) Because the ablation process uses a laser beam, the sidewalls of the features formed in the layer 10 are parallel and perfectly perpendicular to the surface of the layer, assuming that the laser beam is directed perpendicularly to the surface. The beam energy does not have to be perfectly controlled to avoid penetrating the carrier layer 12, because the carrier layer will later be removed. In fact, it is preferable that a portion of the carrier layer 12 be ablated to ensure that the cavity walls are parallel throughout the thickness of the metal layer 10.

As shown in FIG. 1C, the structure is next inverted and the ablated side of the structure is laminated to any thin dielectric material 16, using an dielectric material that has low-flow, no-flow or adhesive-less properties. A minimal amount of dielectric material will encroach into the cavities 14 produced by the laser, but not enough to affect the properties of the completed device. In the final step of the process, as shown in FIG. 1D, the carrier layer 12 is removed to produce the desired device, comprising the metal layer 10 with the desired pattern features 14, laminated to the dielectric layer 16.

The principal advantage of the method of the invention is that it can form pattern features to a high degree of precision, limited only by the precision and repeatability of the apparatus used to translate the laser across the metal layer 10. Further, the features 14 are formed with straight and parallel sidewalls, without the prior art concern for the consequences of under-etching or over-etching. The laser must simply be selected to provide sufficient energy to penetrate all the way through the copper layer 10. Partial penetration of the carrier layer 12 is of no concern because that layer is subsequently removed.

Devices that can advantageously employ the present invention include devices that have frequency selective surfaces to perform various functions in processing incident electromagnetic radiation. For example, devices performing a multiplexing function, such as the one described in U.S. Pat. No. 5,959,594 to Te-Kao Wu et al., would benefit from use of the present invention for fabrication, to allow the reliable and repeatable manufacture of such devices to operate at high frequencies, e.g., above 50 GHz. The invention may also be usefully employed in the fabrication of polarizers, printed phased array aperture elements, beam forming devices and various related products. In fact, the invention may be advantageously employed to manufacture any device that has a requirement for the formation of geometric patterns on a thin metal layer to a high degree of precision.

It will be appreciated from the foregoing that the present invention represents a significant advance in the field of fabrication of devices having metal layers that must be patterned to a high degree of precision. Specifically, the present invention facilitates the patterning of a metal layer more precisely than wet chemical etching and without the cross-sectional shape distortions associated with chemical etching.

It will also be appreciated that, although a specific embodiment of the invention has been described in detail, various modifications may be made that are within the spirit and scope of the invention. Accordingly, the invention should not be limited except as by the appended claims.

1. A method for forming a pattern of geometric features in a thin metal layer, comprising the steps of:
taking a structure that includes a thin metal layer removably mounted on a carrier layer;
forming a pattern of desired geometric features in the thin metal layer using a laser to ablate the metal layer;
laminating the thin metal layer and the entire structure to a dielectric layer; and
removing the carrier layer to leave the patterned thin metal layer laminated to the dielectric layer;
whereby forming the pattern by laser ablation results in more precisely formed pattern features and in desirably parallel feature sidewalls.

2. A method as defined in claim 1, wherein the forming step uses a neodymium (Nd) and yttrium aluminum garnet (YAG) or other applicable laser.

3. A method as defined in claim 1, wherein the laminating step uses a low-flow or no-flow adhesive dielectric material.

4. A method as defined in claim 1, wherein the laminating step uses an adhesive-less dielectric material.

5. A method as defined in claim 1, wherein the forming step penetrates the entire thickness of the metal layer and partially penetrates the carrier layer.

6. A method as defined in claim 1, wherein the metal layer and the carrier layer are both of copper material.
